(19) United States
(12) Patent Application Publication
(10) Pub. No.: US 2022/0005074 A1
(43) Pub. Date: Jan. 6, 2022

(54) INFORMATION PROCESSING DEVICE, INFORMATION PROCESSING PROGRAM, AND INFORMATION PROCESSING SYSTEM

(71) Applicant: TOYOTA JIDOSHA KABUSHIKI KAISHA, Toyota-shi (JP)

(72) Inventors: Kazuyuki INOUE, Nagoya-shi (JP); Kuniaki JINNAI, Nagoya-shi (JP); Kenichiro FUJIMORI, Tokyo (JP); Kohei TSUDA, Tokyo (JP); Noriaki MOCHIDA, Nagoya-shi (JP); Shuhei OCHIAI, Nagoya-shi (JP); Satoru SAKAMOTO, Tokyo (JP); Masashi KAMAKURA, Ichikawa-shi (JP)

(73) Assignee: TOYOTA JIDOSHA KABUSHIKI KAISHA, Toyota-shi (JP)

(21) Appl. No.: 17/364,329

(22) Filed: Jun. 30, 2021

(30) Foreign Application Priority Data
Jul. 3, 2020 (JP) 2020-115818

(51) Int. Cl. G06Q 30/02

(52) U.S. Cl. CPC G06Q 30/0261

(57) ABSTRACT

An information processing device according to the present disclosure includes a processor having hardware. The processor extracts an area that a user has passed based on location information of a device that moves with the user, acquires donation information of the extracted area, to create guidance information including the acquired donation information, and displays the guidance information on a user terminal of the user.

### CROSS-REFERENCE TO RELATED APPLICATION

This application claims priority to Japanese Patent Application No. 2020-115818 filed on Jul. 3, 2020, incorporated herein by reference in its entirety.

### BACKGROUND

### 1. Technical Field

The present disclosure relates to an information processing device, an information processing program, and an information processing system.

### 2. Description of Related Art

Japanese Unexamined Patent Application Publication No. 2013-109674 (JP 2013-109674 A) discloses a technique for providing a user with information regarding donations based on a user's purchase history. In JP 2013-109674 A, the server extracts donation information according to the conditions (donation target products or donation target services) input by the user and transmits the donation information to the user.

### SUMMARY

In the technique disclosed in JP 2013-109674 A, the content of the product or service is a condition of the search, and thus, the technique does not contribute to the area visited by the user.

The present disclosure has been made in view of the above, and an object of the present disclosure is to provide an information processing device, an information processing program, and an information processing system capable of providing guidance on donations to an area visited by a user.

An information processing device according to the present disclosure includes a processor having hardware. The processor extracts an area that a user has passed based on location information of a device that moves with the user, acquires donation information of the extracted area, to create guidance information including the acquired donation information, and displays the guidance information on a user terminal of the user.

An information processing program according to the present disclosure that causes a processor having hardware to: extract an area that a user has passed based on location information of a device that moves with the user; acquire donation information of the extracted area, to create guidance information including the acquired donation information; and display the guidance information on a user terminal of the user.

An information processing system according to the present disclosure includes: an information processing device including a first processor having hardware, the first processor extracting an area that a user has passed based on location information of a device that moves with the user, acquiring donation information of the extracted area, to create guidance information including the acquired donation information, and displaying the guidance information on a display; and a terminal including a second processor having hardware and the display.

According to the present disclosure, it is possible to provide guidance on donations to the area visited by the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a wallet system according to an embodiment;

FIG. 2 is a block diagram schematically showing a configuration of a wallet server according to the embodiment;

FIG. 3 is a block diagram schematically showing a configuration of a payment service provider server according to the embodiment;

FIG. 4 is a block diagram schematically showing a configuration of a user terminal according to the embodiment;

FIG. 5 is a diagram schematically showing a relationship between a payment means, a charging means, and a payment settlement means in the wallet system according to the embodiment;

FIG. 6 is a block diagram schematically showing a configuration of a vehicle according to the embodiment;

FIG. 7 is a flowchart illustrating a guidance information creation process performed by the wallet server according to the embodiment;

FIG. 8 is a diagram showing an example in which a guidance screen is displayed on an operation display unit of the user terminal in the wallet system according to the embodiment; and

FIG. 9 is a diagram showing an example in which a payment settlement screen is displayed on the operation display unit of the user terminal in the wallet system according to a modification.

### DETAILED DESCRIPTION OF EMBODIMENTS

Hereinafter, embodiments of the present disclosure will be described below with reference to the drawings. In all the drawings of the following embodiments, the same or corresponding portions are designated by the same reference signs. Further, the present disclosure is not limited to the embodiments described below.

Wallet System

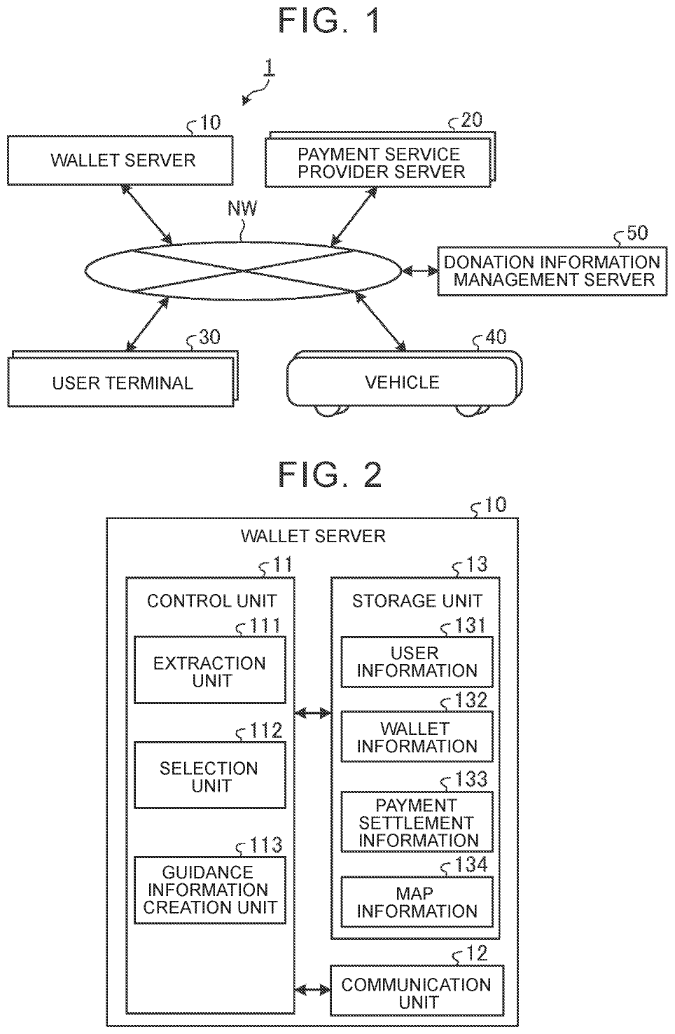

A wallet system to which an information processing device according to the embodiment of the present disclosure can be applied will be described with reference to the drawings. FIG. 1 is a diagram schematically showing a configuration of the wallet system according to an embodiment. As shown in FIG. 1, a wallet system 1 according to the present embodiment includes a wallet server 10, a payment service provider server 20, a user terminal 30, a vehicle 40, and a donation information management server 50 that can communicate with each other via a network NW.

The network NW is composed of, for example, the Internet network and a mobile phone network. The network NW is, for example, a public communication network such as the Internet, and may include a telephone communication network such as a wide area network (WAN) and a mobile phone, and other communication networks such as a wireless communication network including WiFi (registered trademark).

Wallet Server

FIG. 2 is a block diagram schematically showing a configuration of a wallet server according to the embodiment. The wallet server 10 serving as a first server including an information processing device is a server for comprehensively managing the wallet system according to the present embodiment, and is managed by a wallet system administrator. As shown in FIG. 2, the wallet server 10 includes a control unit 11 serving as a first processor, a communication unit 12, and a storage unit 13.

Specifically, the control unit 11 is composed of a processor that is provided with hardware, such as a central processing unit (CPU), a digital signal processor (DSP), and a field-programmable gate array (FPGA), and a main storage unit, such as a random access memory (RAM) and a read-only memory (ROM). The storage unit 13 includes, for example, a storage medium selected from an erasable programmable ROM (EPROM), a hard disk drive (HDD), and a removable medium, etc. Examples of the removable medium include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases, etc. The control unit 11 loads a program stored in the storage unit 13 into a work area of the main storage unit and executes the loaded program, and controls each component unit, etc. through execution of the program. Note that, the program may be a learned model generated through machine learning such as deep learning, for example. Thereby, the control unit 11 can realize the functions of an extraction unit 111, a selection unit 112, and a guidance information creation unit 113. The details of the functions of the extraction unit 111, the selection unit 112, and the guidance information creation unit 113 will be described later.

The communication unit 12 is, for example, a local area network (LAN) interface board or a wireless communication circuit for wireless communication. The LAN interface board and the wireless communication circuit are connected to the network NW such as the Internet, which is a public communication network. The communication unit 12 connects to the network NW and communicates with the payment service provider server 20, the user terminal 30, the vehicle 40, and the donation information management server 50.

The storage unit 13 according to the present embodiment stores user information 131, wallet information 132, and payment settlement information 133 for each user of the wallet system. The storage unit 13 also stores map information 134 of various locations. Further, the storage unit 13 stores a program for executing the guidance information creation process described later.

The user information 131 is information about the user who uses the wallet system. Examples of the user information 131 include, for example, a user ID, a password, a user name, user contact information (for example, an address, a telephone number, and an e-mail address), usage registration history, and information on payment means registered as deposit means, information on payment means registered as payment settlement means, and a password for performing a payment settlement, and a movement history of the user by the vehicle 40, of the user who has registered for use of the wallet system. The user ID and the password in the user information 131 are used for authentication processing such as logging in to the wallet server 10.

The wallet information 132 is information related to a wallet of the wallet system. The wallet is a virtual deposit and withdrawal account of electronic money. The wallet information 132 includes, for example, the user ID, a balance of the electronic money, a deposit history of the electronic money, and a usage history of the electronic money.

The payment settlement information 133 is information related to payment settlement of the wallet system. The payment settlement information 133 includes the user ID, a payment settlement means used for performing the payment settlement (e.g. electronic money payment (non-contact payment), scan payment, or code payment), and a payment settlement history.

The map information 134 is map information for selecting an area based on the movement history of the user who uses the wallet system. Examples of the map information 134 include map data in which road information including a route on which the vehicle 40 on which the user rides can travel is registered.

### Payment Service Provider Server

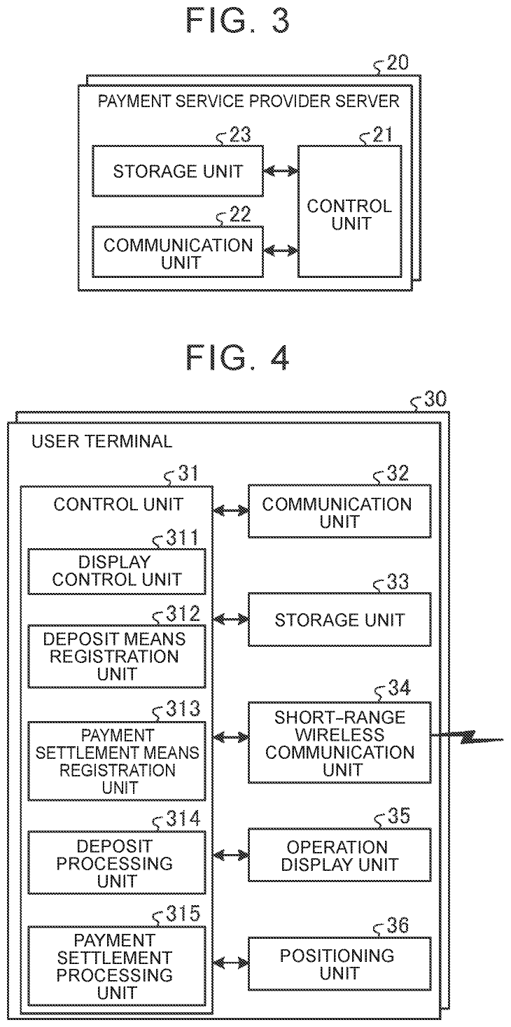

FIG. 3 is a block diagram schematically showing a configuration of the payment service provider server according to the embodiment. The payment service provider server 20 is a server for managing accounts and credit cards of the users and is provided in a financial institution (e.g. a bank, a credit union, a credit association, or a labor bank) or a credit card company. As shown in FIG. 3, the payment service provider server 20 includes a control unit 21, a communication unit 22, and a storage unit 23. The control unit 21, the communication unit 22, and the storage unit 23 are physically the same as the control unit 11, the communication unit 12, and the storage unit 13, respectively.

The storage unit 23 stores account information and credit card information for each user of the wallet system. The account information includes, for example, the user's name, account number, account balance, and deposit and withdrawal history. The credit card information includes, for example, the user's name, credit card number, an expiration date of the credit card, usage limit amount, and card usage history.

User Terminal

FIG. 4 is a block diagram schematically showing a configuration of the user terminal according to the embodiment. The user terminal 30 is a computer terminal used by the user. Examples of the user terminal 30 include smartphones, mobile phones, tablet terminals, wearable computers, and personal computers held by the user, and car navigation systems mounted on vehicles. The user terminal 30 may be any terminal as long as it can transmit and receive information to and from the wallet server 10.

As shown in FIG. 4, the user terminal 30 includes a control unit 31 serving as a second processor, a communication unit 32, a storage unit 33, a short-range wireless communication unit 34, an operation display unit 35 such as a display, and a positioning unit 36. The control unit 31, the communication unit 32, and the storage unit 33 are physically the same as the control unit 11, the communication unit 12, and the storage unit 13, respectively. The control unit 31 functions as a display control unit 311, a deposit means registration unit 312, a payment settlement means registration unit 313, a deposit processing unit 314, and a payment settlement processing unit 315 through the execution of the program.

The display control unit 311 controls display content on the operation display unit 35. The display control unit 311 displays, based on the operation by the user (touch operation, flick operation, etc.), a member registration screen for registration of the user as a member, a login screen for logging in to the wallet system, a deposit screen for depositing electronic money to the wallet, a payment settlement screen for performing payment settlement, a usage history screen showing a list of usage history such as payment settlement, a payment history detail screen showing details of payment history, a code payment screen, a scan payment screen, and the like, on the operation display unit 35. The display control unit 311 transitions the screen based on the operation of the user. In addition, the display control unit 311 displays a display screen based on the guidance information received from the wallet server 10. Various configurations can be adopted for the screen configurations of the payment settlement screen, the usage history screen, the payment history detail screen, the code payment screen, and the guidance screen based on the guidance information.

The deposit means registration unit 312 registers the deposit means for depositing electronic money. Specifically, the deposit means registration unit 312 transmits, to the wallet server 10, a deposit means registration request for registration of a plurality of different payment means operated by a plurality of businesses (for example, a bank account, a credit card, a virtual credit card, etc.) as a deposit means to the wallet. The control unit 11 of the wallet server 10 that receives the deposit means registration request from the deposit means registration unit 312 stores, as the user information 131, the payment means contained in the deposit means registration request in the storage unit 13, to register the payment means as the deposit means.

The deposit means registration unit 312 also registers the payment means to be registered as the payment settlement means as the deposit means. That is, the deposit means registration unit 312 transmits, to the wallet server 10, the deposit means registration request to register, as the payment settlement means, the payment means included in the payment settlement means registration request, when the payment settlement means registration request is transmitted from the payment settlement means registration unit 313 to the wallet server 10. The control unit 11 of the wallet server 10 that receives the deposit means registration request from the deposit means registration unit 312 stores, as the user information 131, the payment means contained in the deposit means registration request in the storage unit 13, to register the payment means as the deposit means.

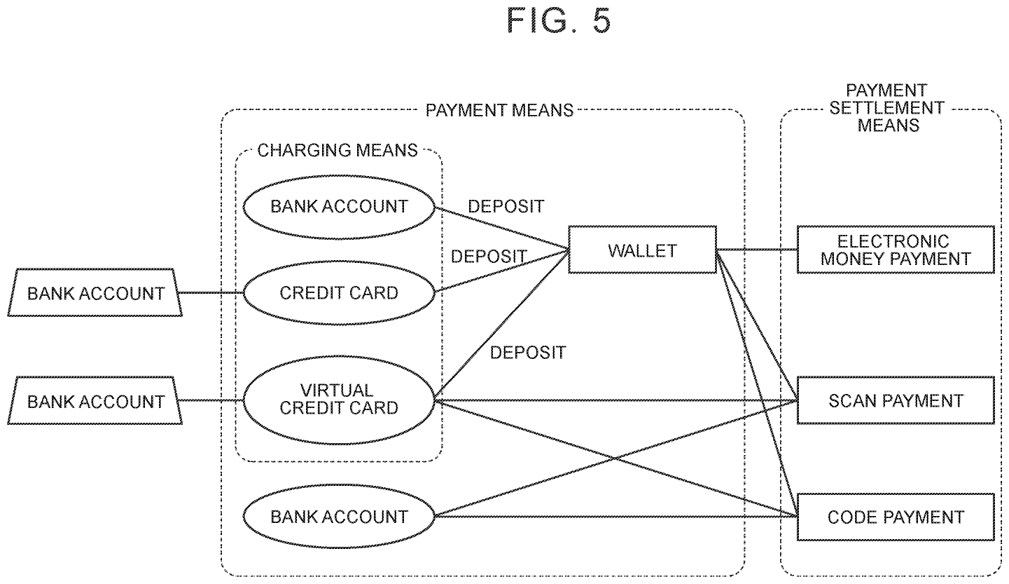

Here, FIG. 5 is a diagram schematically showing the relationship between the payment means, the charging means, and the payment settlement means in the wallet system according to the present embodiment. The “payment means” refers to a means that serves as a payment source (funding source) when performing a payment settlement. The payment means include bank accounts, credit cards, virtual credit cards and the balance of electronic money in wallets. The virtual credit card is a credit card without substance, and is composed of information such as a card number, an expiration date, and an authentication number (security code). In addition, a bank account is linked to each of the credit card and the virtual credit card, and the usage amount of each card is deducted from the bank account at a later date.

The “charging means” refers to a means for depositing electronic money into a wallet, which is a virtual deposit/withdrawal account. The charging means includes bank accounts, credit cards and virtual credit cards, out of the payment means. By registering a bank account, a credit card and a virtual credit card as the charging means, it is possible to deposit electronic money into the wallet.

The “payment settlement means” refers to a means of performing a payment settlement using the payment means. The payment settlement means includes electronic money payment, scan payment and code payment. The electronic money payment is payment settlement performed in a non-contact manner between the short-range wireless communication unit 34 of the user terminal 30 and the short-range wireless communication unit of the terminal of a store etc. by holding the user terminal 30 over the terminal of the store etc. Further, the scan payment is a payment settlement performed by reading a barcode or a QR code (registered trademark) displayed on the terminal of the store etc. with a camera or the like of the user terminal 30. Further, the code payment is a payment settlement performed by reading a barcode or QR code (registered trademark) displayed on the user terminal 30 with a code reader or the like of the terminal of the store etc.

In the wallet system according to the present embodiment, any of the three types of payment settlement means can be used with the three types of payment means. That is, in the wallet system, it is possible to combine the payment means and the payment settlement means as in (1) to (3) below.
(1) Electronic money payment, scan payment and code payment using the balance of electronic money in the wallet
(2) Electronic money payment, scan payment and code payment using a virtual credit card
(3) Electronic money payment, scan payment and code payment using a bank account

As described above, in the wallet system according to the present embodiment, it is possible to deposit electronic money into the wallet by a plurality of payment means, and the balance of the electronic money deposited in the wallet can be used to perform the payment settlement through the plurality of payment settled means.

With reference to FIG. 4, the payment settlement means registration unit 313 also registers, as the payment settlement means, the payment means to be registered as the deposit means. That is, the payment settlement means registration unit 313 transmits, to the wallet server 10, the payment settlement means registration request for registering, as the payment settlement means, the payment means included in the deposit means registration request when the deposit means registration request is transmitted from the deposit means registration unit 312 to the wallet server 10.

For example, when a payment means (bank account of A bank) is registered as the deposit means, the payment settlement means registration unit 313 automatically registers the payment means (bank account of A bank) as the payment settlement means. Note that “registering a payment means as a payment settlement means” means making the payment means available as a payment source for payment settlement, and means for example, enabling electronic money payment, scan payment, and code payment. The control unit 11 of the wallet server 10 that receives the payment settlement means registration request from the payment settlement means registration unit 313 stores the payment means contained in the payment settlement means registration request in the storage unit 13 as the user information 131, so as to register the payment means as the payment settlement means.

The deposit processing unit 314 deposits electronic money into the wallet. Specifically, the deposit processing unit 314 transmits, to the wallet server 10, a deposit request for depositing electronic money into the wallet using the payment means registered as the deposit means. The control unit 11 of the wallet server 10 that receives the deposit request from the deposit processing unit 314 increments a balance of the electronic money in the wallet based on deposit amount information contained in the deposit request. That is, the control unit 11 updates the wallet information 132 stored in the storage unit 13 in accordance with the increment in the balance of the electronic money in the wallet.

The payment settlement processing unit 315 performs a payment settlement by the payment means. The payment settlement processing unit 315 transmits, to the wallet server 10, a payment settlement request for performing a payment settlement using the electronic money deposited in the wallet through any of the plurality of preset payment settlement means (electronic money payment, scan payment, code payment). For example, when performing the electronic money payment, the payment settlement processing unit 315 transmits a payment settlement request to the wallet server 10 through the network NW. When performing the scan payment, the payment settlement processing unit 315 reads a barcode or a QR code (registered trademark) displayed on the terminal of the store etc. with the camera or the like of the user terminal 30, so as to transmit the payment settlement request to the wallet server 10. When performing the code payment, the payment settlement processing unit 315 causes the code reader or the like of the store etc. to read a barcode or a QR code (registered trademark) displayed on the user terminal 30, so as to transmit the payment settlement request to the wallet server 10. The payment settlement request transmitted from the payment settlement processing unit 315 to the wallet server 10 may or may not include information indicating the payment settlement amount (hereinafter, referred to as “payment settlement amount information”).

Subsequently, the control unit 41 of the vehicle 40 transmits a payment settlement request including the payment settlement amount information to the wallet server 10 via the network NW. The control unit 11 of the wallet server 10 that receives the payment settlement request from the vehicle 40 decrements the balance of the electronic money in the wallet based on the payment settlement amount contained in the payment settlement request. That is, the control unit 11 updates the wallet information 132 and the payment settlement information 133 stored in the storage unit 13 in accordance with the decrement in the balance of the electronic money in the wallet.

The payment settlement processing unit 315 can also perform a payment settlement by a payment means other than the balance of electronic money in the wallet (for example, a bank account or a credit card). In this case, the payment settlement processing unit 315 transmits, to the wallet server 10, a payment settlement request for performing a payment settlement using any of the plurality of payment settlement means with the bank account or the credit card. The control unit 11 of the wallet server 10 that receives the payment settlement request from the payment settlement processing unit 315 transmits the payment settlement amount information contained in the payment settlement request to the payment service provider server 20.

The storage unit 33 stores various screen data to be displayed on the operation display unit 35 by the display control unit 311. Further, the storage unit 33 continuously or temporarily stores the user information 131, the wallet information 132, the payment settlement information 133, the map information 134, and the like, as needed.

The short-range wireless communication unit 34 has a communication function conforming to standards such as near field radio communication (NFC), Bluetooth (registered trademark) low energy (BLE), and infrared data association (IrDA). For example, when the user makes a payment using the electronic money, the user terminal 30 performs short-range wireless communication with the terminal of the store etc. through the short-range wireless communication unit 34.

The operation display unit 35 is composed of, for example, a touch panel display, and has an input function for receiving an operation of the user with a finger or a pen and a display function for displaying various types of information based on the control of the display control unit 311.

The positioning unit 36 receives radio waves from a global positioning system (GPS) satellite and detects the location of the user terminal 30, for example. The location and route of the user terminal 30 detected by the positioning unit 36 serving as the location information acquisition unit of the user terminal 30 are stored in the storage unit 33 as route information including the location in the traveling information.

Vehicle

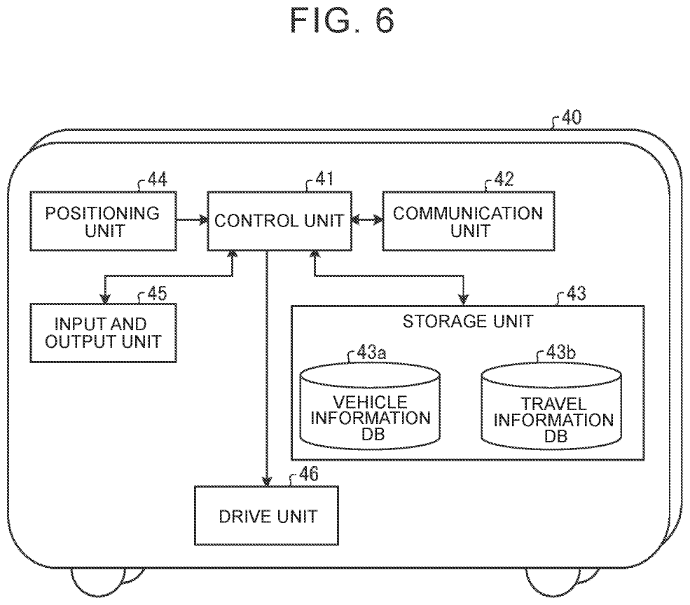

FIG. 6 is a block diagram schematically showing a configuration of the vehicle according to the embodiment of the present disclosure. The vehicle 40 serving as a moving body is a vehicle that travels as a driver drives the vehicle, or an autonomously traveling vehicle configured to be able to autonomously travel in accordance with a given travel command. As shown in FIG. 6, the vehicle 40 includes the control unit 41, a communication unit 42, a storage unit 43, a positioning unit 44, an input and output unit 45, and a drive unit 46.

The control unit 41, the communication unit 42, and the storage unit 43 are physically the same as the control unit 11, the communication unit 12, and the storage unit 13. The control unit 41 comprehensively controls the operation of various components mounted on the vehicle 40. The communication unit 42 serving as a communication terminal of the vehicle 40 is composed of, for example, a data communication module (DCM) that communicates with the wallet server 10 by wireless communication via the network NW.

The storage unit 43 includes a vehicle information database 43a and a travel information database 43b. In the vehicle information database 43a, various information including a state of charge (SOC), a remaining fuel amount, a vehicle size information, and the like are stored in an updatable manner. In the travel information database 43b, various information including travel information related to the travel route is stored in an updatable manner. The travel information is information measured and generated by the control unit 41 based on the information obtained from the positioning unit 44 and the drive unit 46.

The positioning unit 44 is physically the same as the positioning unit 36. The location and the route of the vehicle 40 detected by the positioning unit 44 serving as the location information acquisition unit of the vehicle 40 are stored in the vehicle information database 43a in a searchable manner as s the location information in the travel information and the travel information. As a method for detecting the location of the vehicle 40, a method combining light detection and ranging or laser imaging detection and ranging (LiDAR) system and a three-dimensional digital map may be adopted.

The input and output unit 45 is composed of a touch panel display and a speaker microphone, etc. The input and output unit 45 serving as an output means is configured to be able to notify the outside of predetermined information, by displaying characters, figures, etc. on the screen of the touch panel display or by outputting a sound or voice from the speaker microphone, in accordance with the control by the control unit 41. Further, the input and output unit 45 serving as an input means is configured to be able to input predetermined information to the control unit 41 when the user or the like operates the touch panel display or outputs a voice to the speaker microphone, etc.

The vehicle 40 according to the present embodiment has the positioning unit 44 and the input and output unit 45 as separate functions. However, the vehicle 40 may include an on-board navigation system that is provided with a communication function and that has both functions of the positioning unit 44 and the input and output unit 45, in place of the positioning unit 44 and the input and output unit 45.

The drive unit 46 is a drive unit that performs driving necessary for the vehicle 40 to travel. Specifically, the vehicle 40 includes an engine as a drive source. The engine is configured to be able to generate electric power using an electric motor, for example, with driving by combustion of fuel. A rechargeable battery is charged using the generated electric power. Further, the vehicle 40 includes: a drive transmission mechanism for transmitting a driving force of the engine; and drive wheels etc. for traveling.

The vehicle 40 may be provided with a short-range wireless communication unit having a communication function conforming to standards such as NFC, BLE, or IrDA.

Donation Information Management Server

The donation information management server 50 is a server for managing information regarding donations planned in the area. The donation information management server 50 includes a control unit, a communication unit, and a storage unit that are physically the same as the control unit 11, the communication unit 12, and the storage unit 13. The donation information management server 50 stores, for example, information of a donation type, a donation destination, a donation amount, and a donation deadline, for each donation type. The types of donations include tax payments and donations. For example, the tax payments include hometown tax payment, and as information regarding the hometown tax payment, areas where the hometown tax payment is performed, return gifts from the areas, the selection of the usage of donation, and the like are registered. Regarding donations in the event of a disaster, information on the disaster situation and supplies necessary for the disaster area are registered.

Guidance Information Creation Method

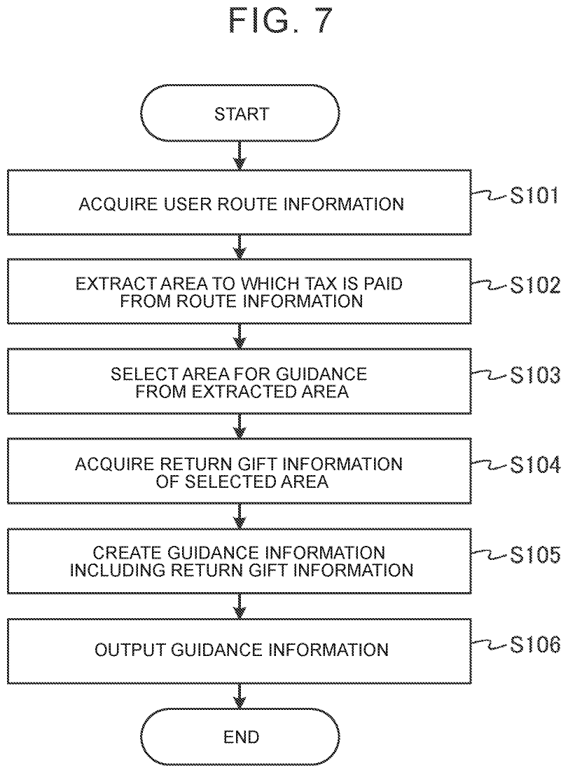

Next, a method of creating guidance information regarding donations by the wallet system 1 according to the present embodiment that is configured as described above will be described. FIG. 7 is a flowchart illustrating a guidance information creation process performed by the wallet server according to the embodiment of the present disclosure. The guidance information creation process described below is a process for creating information for guiding the target user to the area for which the hometown tax payment is performed, and is executed by the wallet server 10.

The control unit 11 acquires the route information of the user to whom the guidance information is transmitted (step S101). The control unit 11 acquires the route information of the user to start the guidance information creation process, with the input of the guidance information request from the user or a predetermined transmission timing of the guidance information being as a trigger.

After the route information is acquired, the extraction unit 111 extracts the area where the hometown tax payment is performed based on the location information of the device (here, the vehicle 40) that moves with the user (step S102). The extraction unit 111 extracts the hometown tax payment performing area in an area where the user has passed, based on the travel route of the vehicle 40 that the user has boarded and that moves with the user.

After that, the selection unit 112 selects the area for guidance according to the preset conditions (step S103). At this time, the selection unit 112 selects all the areas that the user has passed, selects areas where the user has stayed for a preset time or longer, or selects only destinations set for traveling and confirmed to be actually visited, for example.

After selecting the area, the guidance information creation unit 113 acquires the hometown tax payment information, that is, return gift information here, for the selected area (step S104). Then, the guidance information creation unit 113 creates guidance information including the guidance area for hometown tax payment and the return gift information in that area (step S105).

When the guidance information is created, the control unit 11 outputs the guidance information to the user terminal 30 of the target user (step S106). On the user terminal 30, an image based on the guidance information created by the wallet server 10 is displayed.

For the guidance information creation process, an example of creating guidance information regarding hometown tax payment has been described, but guidance information regarding other donations can be created. When the donation has a deadline, the guidance information creation unit 113 may set display of the deadline or the number of days remaining until the deadline.

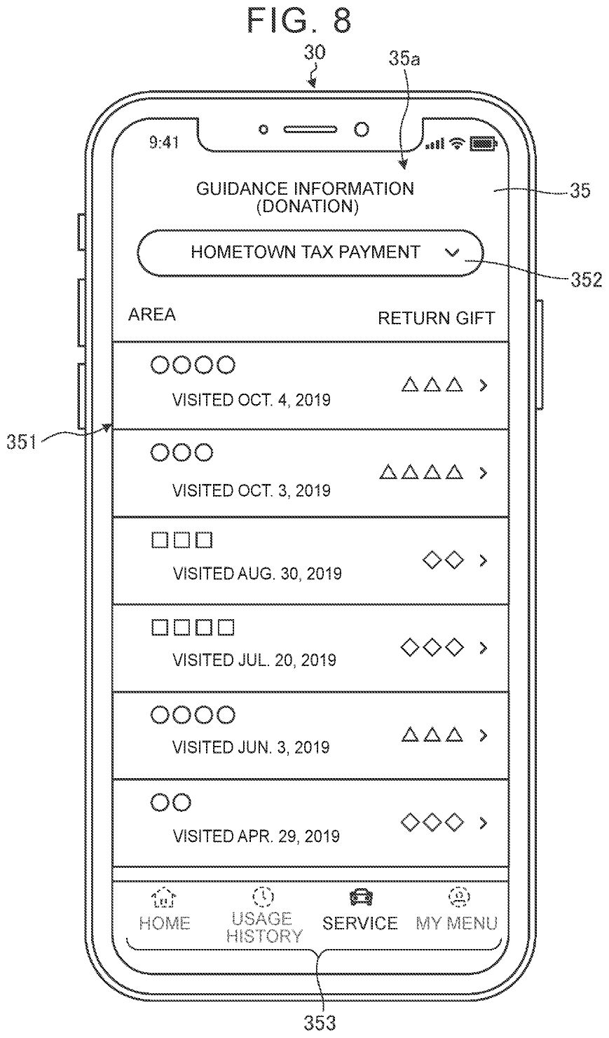

When the user terminal 30 receives the guidance information, the display control unit 311 causes the operation display unit 35 to display the guidance information. FIG. 8 is a diagram showing an example in which a guidance screen is displayed on the operation display unit of the user terminal in the wallet system according to the embodiment. The guidance screen 35a shown in FIG. 8 is displayed on the user terminal 30 that has received the guidance information. The display control unit 311 displays a list of areas of the hometown tax payment and the return gift information of the areas, which is created based on the user's movement history on the guidance screen 35a. For example, the areas and the dates of visit are displayed on the left side, and the return gifts from the areas are displayed on the right side. When an area is selected by the user touching an area selection region 351 or the like, for example, the details of the hometown tax payment, images introducing the area, or a screen displaying the selection button for transitioning to the screen for actually performing the hometown tax payment (for example, payment settlement screen). In addition, the type of donation can be selected from a pull-down menu 352.

A menu switching region 353 is a region for switching the menu items. In the example shown in FIG. 8, the menu items include home, usage history, service, and my menu. The “home” is a menu item for displaying the payment settlement screen. The “usage history” is a menu item for displaying the usage history screen. The “service” is a menu item for displaying a page related to a service for which the wallet system according to the present embodiment can be used, and is a menu item for displaying a guidance screen as shown in FIG. 8. The “my menu” is a menu item for displaying a page for inquiring/changing the user information 131.

In the embodiment described above, the wallet server 10 creates guidance information for providing guidance on donation information of the visited area based on the movement history of the user, and outputs the guidance information to the user terminal 30. According to the embodiment, by displaying the guidance information on the user terminal 30, it is possible to provide guidance on the donation to the area visited by the user himself/herself.

### Modification

Next, a modification will be described. The configuration of the wallet system 1 is the same as that of the embodiment. In the modification, the guidance information is created by further taking personal information into consideration in the guidance information creation process.

For example, when creating the guidance information, the guidance information creation unit 113 acquires personal information such as personal attributes, payment settlement means usage information, or balance information from the user information 131 together with the selected area. The personal attributes are information about a personal environment such as a family structure, cohabitation/non-cohabitation, a personal income, and the like.

For example, when the guidance information creation unit 113 acquires information regarding the presence or absence of a spouse or a child as the personal attributes, the guidance information creation unit 113 extracts the return gift information suitable for the attributes from the return gift information of the selected area. The guidance information creation unit 113 performs a setting to preferentially display the area corresponding to the extracted return gift information. For example, on the guidance screen shown in FIG. 8, the area of the return gift suitable for the personal attributes is displayed in the upper part.

Further, the guidance information creation unit 113 calculates, for example, an upper limit amount that can be spent based on the income and performs a setting to display the calculated upper limit amount, when information on income is acquired as the personal attributes.

Further, for example, when the guidance information creation unit 113 acquires information on the frequency of use of each payment settlement means as the usage information of the payment settlement means, the guidance information creation unit 113 performs a setting to provide guidance on the payment settlement means with high frequency of use or the amount that can be paid in accordance with the balance when the screen transitions to the payment settlement screen for performing the hometown tax payment.

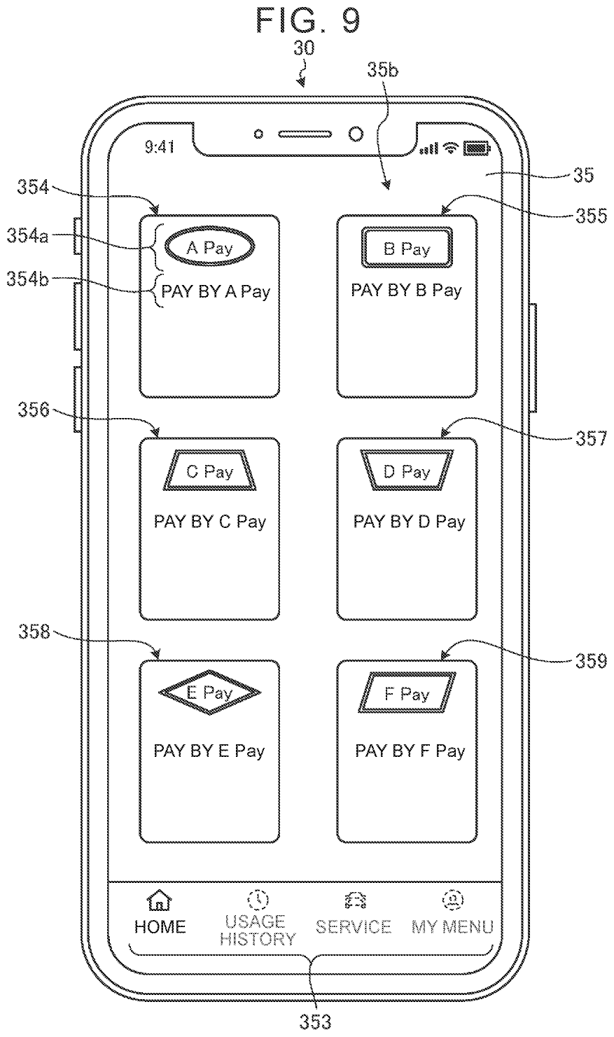

FIG. 9 is a diagram showing an example in which the payment settlement screen is displayed on the operation display unit of the user terminal in the wallet system according to the modification. A payment settlement screen 35b shown in FIG. 9 is displayed on the user terminal 30. FIG. 9 shows, as an example, the payment settlement screen 35b when “A Pay”, “B Pay”, “C Pay”, “D Pay”, “E Pay”, and “F Pay” are registered as the payment settlement methods. Specifically, the payment settlement screen 35b includes a menu switching region 353 and payment settlement icons 354 to 359 displayed in a list. The payment settlement screen 35b is, for example, a screen displayed for the donation selected on the guidance screen.

The payment settlement icons 354 to 359 are regions for displaying the payment settlement methods, and accept a request for payment settlement using the displayed payment settlement methods. The display control unit 311 causes the payment settlement icon 354 to display a payment settlement name 354a indicating the name of the payment settlement method that can be used on the user terminal 30 and a payment settlement phrase 354b clearly indicating that the payment settlement is performed by the payment settlement method. Specifically, in the payment settlement icon 354, a mark (logo mark, acceptance mark, etc.) including the name of “A Pay” is displayed as the payment settlement name 354a, and characters “pay by A Pay” are displayed as the payment settlement phrase 354b. The upper limit amount that can be spent may be displayed on the payment settlement screen 35b. The payment settlement icons 355 to 359 also display the names of the payment settlement methods, the marks indicating the payment settlement methods, the payment settlement phrases, and the like, but the functions are the same as those of the payment settlement icon 354.

Here, in FIG. 9, when the payment settlement icon 354 indicating “A Pay” is selected by the user, the display control unit 311 displays a screen for electronic payment settlement prepared in advance. When the control unit 11 receives an input for confirming the payment settlement from the user on the electronic payment settlement screen, the control unit 11 transmits a payment settlement request for performing a payment settlement to the wallet server 10. The control unit 11 of the wallet server 10 that receives the payment settlement request from the payment settlement processing unit 315 transmits the payment settlement amount information contained in the payment settlement request to the payment service provider server 20.

In the modification described above, the same effects as those of the embodiment can be obtained, and the wallet server 10 adjusts the order of the donation information or the payment settlement information based on the user's personal information. Therefore, information suitable for the user can be displayed on the screen.

### Recording Medium

According to the embodiment, a program capable of executing a processing method by the wallet server 10 or the user terminal 30 can be recorded in the recording medium that is readable by a computer or other machines or devices (hereinafter referred to as “computer or the like”). The computer or the like functions as the control unit of the wallet server 10 or the user terminal 30 when the computer or the like reads the program stored in the recording medium to execute the program. Here, the recording medium that is readable by the computer or the like means a non-transitory recording medium that can accumulate information such as data and programs through electrical, magnetic, optical, mechanical, or chemical action and read the information from the computer or the like. Examples of the recording medium removable from the computer among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording medium fixed to the computer include a hard disk and a read-only memory (ROM). Further, a solid state drive (SSD) can be used as the recording medium removable from the computer or as the recording medium fixed to the computer.

### Other Embodiments

In the wallet system 1 according to the embodiment, the “unit” can be read as a “circuit” or the like. For example, the communication unit can be read as a communication circuit.

The program to be executed by the wallet server 10 or the user terminal 30 according to the embodiment may be configured to be stored in a computer connected to a network such as the Internet and provided through downloading via the network.

The example of the wallet server 10 according to the embodiment has been described in which the area that the user has passed is extracted based on the travel route of the vehicle 40. However, the guidance information regarding donations may be created by extraction of the area that the user has passed based on the location information of the user terminal 30 measured by the user terminal 30 or the like, that is, the location information measured when the user moves by means other than the vehicle 40, such as walking. When the travel route of the vehicle 40 is used as the movement history of the user, the user terminal 30 may not have the positioning unit 36 serving as a function of acquiring the information on the location that the user has passed.

Further effects and modifications can be easily derived by those skilled in the art. The broader aspects of the present disclosure are not limited to the particular details and representative embodiments shown and described above. Accordingly, various modifications may be made without departing from the scope of the general inventive concept defined by the appended claims and their equivalents.

What is claimed is:

1. An information processing device comprising a processor including hardware, wherein the processor
extracts an area that a user has passed based on location information of a device that moves with the user,
acquires donation information of the extracted area to create guidance information including the acquired donation information, and
displays the guidance information on a user terminal of the user.

2. The information processing device according to claim 1, wherein the processor selects, from the extracted area, an area in accordance with a preset condition, and acquires donation information of the selected area to create the guidance information.

3. The information processing device according to claim 2, wherein the condition is all the area that the user has passed.

4. The information processing device according to claim 2, wherein the condition is an area that the user has passed and stayed for a preset time or longer.

5. The information processing device according to claim 2, wherein the condition is an area that the user has passed and has set as a destination.

6. The information processing device according to claim 1, wherein the location information of the device is a travel route of a vehicle on which the user has boarded.

7. The information processing device according to claim 1, wherein the location information of the device is a movement route of the user terminal of the user.

8. The information processing device according to claim 1, wherein the processor sets a display order of the donation information based on a personal attribute of the user.

9. The information processing device according to claim 1, wherein the processor calculates an upper limit amount of a donation amount based on a personal payment settlement history of the user, and displays the upper limit amount.

10. An information processing program that causes a processor having hardware to:
extract an area that a user has passed based on location information of a device that moves with the user;
acquire donation information of the extracted area, to create guidance information including the acquired donation information; and
display the guidance information on a user terminal of the user.

11. The information processing program according to claim 10, the information processing program causing the processor to:
select, from the extracted area, an area in accordance with a preset condition; and
acquire donation information of the selected area to create the guidance information.

12. The information processing program according to claim 11, wherein the condition is all the area that the user has passed.

13. The information processing program according to claim 11, wherein the condition is an area that the user has passed and stayed for a preset time or longer.

14. The information processing program according to claim 11, wherein the condition is an area that the user has passed and has set as a destination.

15. The information processing program according to claim 10, the information processing program causing the processor to set a display order of the donation information based on a personal attribute of the user.

16. The information processing program according to claim 10, the information processing program causing the processor to calculate an upper limit amount of a donation amount based on a personal payment settlement history of the user, and display the upper limit amount.

17. An information processing system, comprising:
an information processing device including a first processor having hardware, the first processor extracting an area that a user has passed based on location information of a device that moves with the user, acquiring donation information of the extracted area, to create guidance information including the acquired donation information, and displaying the guidance information on a display; and
a terminal including a second processor having hardware and the display.

18. The information processing system according to claim 17, wherein the first processor selects, from the extracted area, an area in accordance with a preset condition, and acquires donation information of the selected area to create the guidance information.

19. The information processing system according to claim 18, wherein the condition is all the area that the user has passed.

20. The information processing system according to claim 18, wherein the condition is an area that the user has passed and stayed for a preset time or longer.

21. The information processing system according to claim 18, wherein the condition is an area that the user has passed and has set as a destination.
